(19) United States
(12) Patent Application Publication
(10) Pub. No.: US 2021/0288870 A1
(43) Pub. Date: Sep. 16, 2021

(54) COMMUNICATION DEVICE, INFORMATION PROCESSING METHOD, AND SYSTEM

(71) Applicant: TOYOTA JIDOSHA KABUSHIKI KAISHA, Toyota-shi (JP)

(72) Inventor: Kazushige HAYASHI, Toyota-shi (JP)

(73) Assignee: TOYOTA JIDOSHA KABUSHIKI KAISHA, Toyota-shi (JP)

(21) Appl. No.: 17/110,471

(22) Filed: Dec. 3, 2020

(30) Foreign Application Priority Data
Mar. 16, 2020 (JP) 2020-045274

(51) Int. Cl. H04L 12/24

(52) U.S. Cl. CPC H04L 41/0686; H04L 41/0654

(57) ABSTRACT

A communication device according to a first aspect of the present disclosure is provided in a vehicle. The communication device includes a control unit that starts communication by a packet communication method in a case where the communication device is activated normally when activating the communication device and transmits, to a predetermined server device, by a circuit-switched communication method, notification information for providing a notification that a failure has occurred in the communication device in a case where the communication device is reactivated when activating the communication device.

### CROSS-REFERENCE TO RELATED APPLICATION

This application claims priority to Japanese Patent Application No. 2020-045274 filed on Mar. 16, 2020, incorporated herein by reference in its entirety.

### BACKGROUND

### 1. Technical Field

The present disclosure relates to a communication device, an information processing method, and a system.

### 2. Description of Related Art

Japanese Unexamined Patent Application Publication No. 2012-113616 (JP 2012-113616 A) discloses a technology related to an error code output device. The error code output device disclosed in JP 2012-113616 A outputs an error code by a test program in execution of an operating basic input-output system (BIOS) after activation failures continue to occur at least a predetermined number of times in a computer using the operating BIOS.

### SUMMARY

The present disclosure is to provide a technology capable of providing a notification that a failure has occurred in a communication device provided in a vehicle.

A communication device according to a first aspect of the present disclosure is a communication device provided in a vehicle. The communication device includes a control unit configured to start communication by a packet communication method in a case where the communication device is activated normally when activating the communication device, and transmit, to a predetermined server device, by a circuit-switched communication method, notification information for providing a notification that a failure has occurred in the communication device in a case where the communication device is reactivated when activating the communication device.

An information processing method according to a second aspect of the present disclosure is executed by a communication device provided in a vehicle. The information processing method includes a step of starting communication by a packet communication method in a case where the communication device is activated normally when activating the communication device, and a step of transmitting, to a predetermined server device, by a circuit-switched communication method, notification information for providing a notification that a failure has occurred in the communication device in a case where the communication device is reactivated when activating the communication device.

A system according to a third aspect of the present disclosure is a system including a communication device provided in a vehicle, and a server device. The communication device is configured to start communication by a packet communication method in a case where the communication device is activated normally when activating the communication device, and transmit, to a predetermined server device, by a circuit-switched communication method, notification information for providing a notification that a failure has occurred in the communication device in a case where the communication device is reactivated when activating the communication device.

With each aspect of the present disclosure, it is possible to provide a technology capable of providing a notification that a failure has occurred in a communication device provided in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of an information management system;

FIG. 2 is a block diagram schematically illustrating one example of a functional configuration of a communication device;

FIG. 3 is a flowchart illustrating a process when activating a communication device according to a first embodiment; and

FIG. 4 is a flowchart illustrating a process when activating a communication device according to a second embodiment.

### DETAILED DESCRIPTION OF EMBODIMENTS

The communication device according to a first aspect of the present disclosure is a communication device provided in a vehicle. Further, the communication device according to the first aspect of the present disclosure has a function capable of carrying out communication by at least two methods, that is, a packet communication method and a circuit-switched communication method. When the communication device is activated normally, the control unit starts the communication by the packet communication method. If a failure (malfunction) occurs in the communication device, the communication device may be repeatedly reactivated when activating the communication device. Therefore, in a case where the communication device is reactivated when activating the communication device, the control unit transmits, to a predetermined server device, notification information for providing a notification that a failure has occurred in the communication device. However, if it takes time to transmit, to the predetermined server device, the notification information from the communication device in a state where the communication device is repeatedly reactivated, the communication device may be reactivated again before the notification information is completely transmitted. In this case, the notification information cannot be properly received by the predetermined server device.

One solution for this problem is that the notification information is transmitted to the predetermined server device by the packet communication method, which is the same method used for the communication in a case where the communication device is activated normally. In this case, in the packet communication method, the information to be transmitted is divided into a plurality of packets prior to the transmission. Therefore, it is necessary for the notification information to be divided, in advance, into a plurality of packets in a case where the notification information is transmitted to the predetermined server device. Further, there is also a case where various pieces of information (i.e., information that should originally be transmitted when activating the communication device) are transmitted by the packet communication method when activating the communication device. Accordingly, information other than the notification information may be preferentially transmitted over the notification information in the communication by the packet communication method. Thus, when the notification information is transmitted to the predetermined server device by the packet communication method, it takes time to transmit the notification information. Consequently, the communication device may be reactivated again before the notification information is completely transmitted.

In the communication device according to the first aspect of the present disclosure, the control unit transmits, to the predetermined server device, the notification information by the circuit-switched communication method. It is not necessary for the notification information to be divided, in advance, into a plurality of packets in the communication by the circuit-switched communication method, whereas the division of the notification information is essential in the communication by the packet communication method. Further, it is possible to preferentially transmit the notification information over information other than the notification information by employing the circuit-switched communication method. The circuit-switched communication method is different from the packet communication method where the communication is started when the communication device is activated normally. Consequently, as the control unit transmits, to the predetermined server device, the notification information by the circuit-switched communication method, it is possible to completely transmit the notification information quicker than in a case where the packet communication method is adopted. Therefore, it is possible to prevent the communication device from being reactivated again before the notification information is completely transmitted to the predetermined server device in a state where the communication device is repeatedly reactivated. Accordingly, it is possible to provide a notification that a failure has occurred in the communication device provided in the vehicle.

Hereinafter, specific embodiments of the present disclosure will be described with reference to the drawings. The technical scope of the present disclosure is not limited to dimensions, materials, shapes, and relative arrangements of the components described in the present embodiment unless otherwise specified.

### First Embodiment

Outline of System

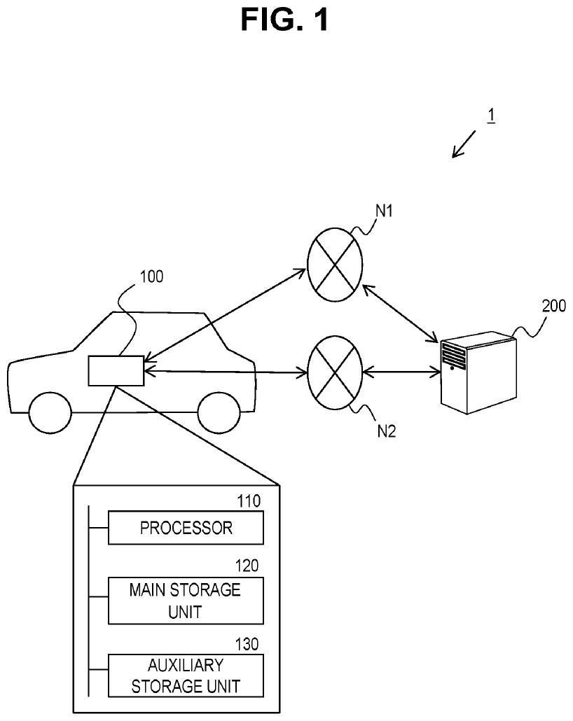

An information management system 1 of the present embodiment will be described hereinbelow with reference to FIG. 1. FIG. 1 is a diagram illustrating a schematic configuration of the information management system 1. The information management system 1 includes a communication device 100 mounted on a vehicle and a management server 200 that manages information transmitted from the communication device 100. In the information management system 1, the communication device 100 and the management server 200 are mutually connected by a network N1 and a network N2.

The communication between the communication device 100 and the management server 200 via the network N1 is carried out by the circuit-switched communication method. A telephone communication network, such as a mobile phone network, is employed as the network N1. Moreover, the communication between the communication device 100 and the management server 200 via the network N2 is carried out by the packet communication method. The network N2 may be, for example, a wide area network (WAN), which is a worldwide public communication network, such as the internet. As described above, the communication device 100 is a communication device having a function capable of carrying out the communication by circuit-switched communication method via the network N1, and communication by the packet communication method via the network N2. A management server 200 of the present embodiment is an example of the “predetermined server device” of the present disclosure.

The communication device 100 includes a computer having a processor 110, a main storage unit 120, and an auxiliary storage unit 130. The processor 110 may be, for example, a central processing unit (CPU) or a digital signal processor (DSP). The main storage unit 120 may be, for example, a random access memory (RAM). The auxiliary storage unit 130 may be, for example, a read-only memory (ROM). The auxiliary storage unit 130 may be, for example, a hard disk drive (HDD), or a disc recording medium, such as a CD-ROM, a DVD, or a Blu-ray Disc. Further, the auxiliary storage unit 130 may be a removable medium (portable storage medium). Examples of the removable medium include a USB memory or an SD card.

In the communication device 100, the auxiliary storage unit 130 stores an operating system (OS), various programs, various tables, and the like. Further, in the communication device 100, the processor 110 can implement various functions, to be described below, by loading and executing programs stored in the auxiliary storage unit 130 into the main storage unit 120. Some or all of the functions of the communication device 100 may be implemented by a hardware circuit, such as an ASIC or an FPGA. Moreover, the communication device 100 does not have to be implemented by a single physical configuration, and may be configured by a plurality of computers that cooperate with each other. The management server 200 also includes a computer, similar to the communication device 100.

In the information management system 1, the communication device 100 starts the communication with the management server 200 via the network N2 when the communication device 100 is activated normally. In other words, when the communication device 100 is activated normally, the communication device 100 starts the communication by the packet communication method. The communication device 100 transmits and receives information on the operation of the communication device 100 by communicating with the management server 200 via the network N2. Examples of the information on the operation of the communication device 100 include information indicating that the communication device 100 has been activated normally. Further, examples of the information transmitted by the communication device 100 to the management server 200 via the network N2 include location information of the vehicle on which the communication device 100 is mounted. The communication device 100 may communicate with a server other than the management server 200 via the network N2.

If the communication device 100 has a failure due to a malfunction, the communication device 100 may be repeatedly reactivated when activating the communication device 100. In such a case, the communication device 100 transmits, to the management server 200, the notification information for providing a notification that a failure has occurred in the communication device 100. However, if it takes time to transmit, to the management server 200, the notification information from the communication device 100 in a state where the communication device 100 is repeatedly reactivated, the communication device 100 may be reactivated again before the notification information is completely transmitted. In this case, the notification information cannot be properly received by the management server 200.

It is assumed that the communication device 100 transmits, to the management server 200, the notification information by the packet communication method via the network N2, the same as in the communication carried out when the communication device 100 is activated normally. In this case, it is necessary to divide, in advance, the notification information into a plurality of packets for transmission. As described above, when the communication device 100 is activated, the information other than the information on the operation of the communication device 100 is transmitted to the management server 200 via the network N2. Therefore, when the notification information is transmitted when the communication device 100 is reactivated, the information other than the notification information may be preferentially transmitted, via the network N2, over the notification information in the communication via the network N2. Thus, when the notification information is transmitted to the management server 200 via the network N2, it takes time to transmit the notification information. Consequently, the communication device 100 may be reactivated again before the notification information is completely transmitted.

Therefore, in the present embodiment, the communication device 100 transmits, to the management server 200, the notification information by a communication method other than that of the network N2 in a case where the communication device 100 is repeatedly reactivated when activating the communication device 100. In other words, the communication device 100 transmits, to the management server 200, the notification information by the circuit-switched communication method via the network N1. It is not necessary to divide, in advance, the notification information into a plurality of packets in the communication by the circuit-switched communication method, whereas the division of the notification information is essential in the communication by the packet communication method. Therefore, the notification information is transmitted to the management server 200 without dividing, in advance, the notification information into a plurality of packets. Moreover, only the notification information is transmitted to the management server 200 by using the network N1 (circuit-switched communication method), which is different from the network N2 (packet communication method) through which transmission of various pieces of information is started when the communication device 100 is activated normally. That is, the notification information can be preferentially transmitted to the management server 200 over the information other than the notification information. Consequently, by transmitting the notification information to the management server 200 via the network N1, it is possible to completely transmit the notification information quicker than in a case where the notification information is transmitted via the network N2.

System Configuration

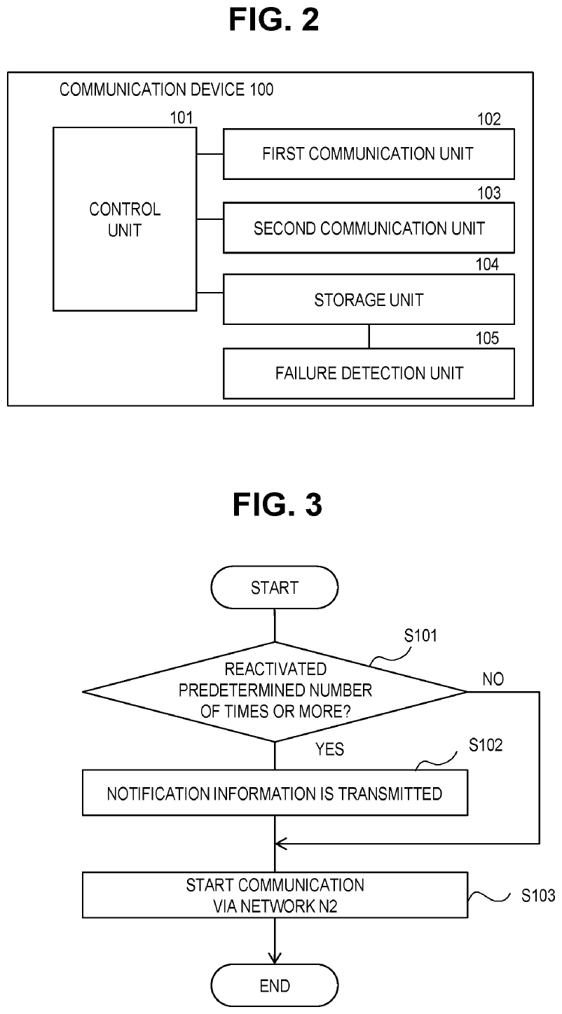

Next, a functional configuration of the communication device 100 included in the information management system 1 according to the present embodiment will be described with reference to FIG. 2. FIG. 2 is a block diagram schematically illustrating one example of the functional configuration of the communication device 100. The communication device 100 includes a control unit 101, a first communication unit 102, a second communication unit 103, a storage unit 104, and a failure detection unit 105.

The control unit 101 has a function of executing an arithmetic process for controlling the communication device 100. The control unit 101 can be implemented by the processor 110. The first communication unit 102 has a function of connecting the communication device 100 to the network N1. The second communication unit 103 has a function of connecting the communication device 100 to the network N2. That is, the information transmitted/received via the first communication unit 102 is transmitted/received by the circuit-switched communication method. Meanwhile, the information transmitted/received via the second communication unit 103 is transmitted/received by the packet communication method. The first communication unit 102 and the second communication unit 103 can be implemented by wireless communication devices.

The failure detection unit 105 has a function of detecting a failure that has occurred in the communication device 100. Further, the failure detection unit 105 has a function of reactivating the communication device 100 when it is detected that a failure has occurred in the communication device 100. Examples of a failure may occur in the communication device 100 include an abnormal voltage occurring in a circuit of the communication device 100. In this case, the failure detection unit 105 is implemented by, for example, a circuit breaker. Further, abnormal heat generation of the communication device 100 can also be exemplified as a failure may occur in the communication device 100. In this case, the failure detection unit 105 is implemented by, for example, a thermal sensor. Well-known devices can be adopted as a device for detecting whether a failure has occurred in the communication device 100. Moreover, well-known methods can be adopted as a method for the failure detection unit 105 to reactivate the communication device 100. The failure detection unit 105 may reactivate the communication device 100 by, for example, transmitting a signal including instructions to reactive the communication device 100 to a reset terminal in the communication device 100.

The storage unit 104 has a function of storing error information and log information. The storage unit 104 can be implemented by the auxiliary storage unit 130. The error information is information for identifying the cause of the failure that has occurred in the communication device 100. The log information is information indicating that the communication device 100 has been reactivated by the failure detection unit 105. Upon detecting a failure that has occurred in the communication device 100, the failure detection unit 105 generates the error information and the log information. The failure detection unit 105 stores the log information and the error information in the storage unit 104 before reactivating the communication device 100.

Process at Activation

Next, a process executed by the control unit 101 when activating the communication device 100 in the information management system 1 according to the present embodiment will be described with reference to FIG. 3. FIG. 3 is a flowchart illustrating the process when activating the communication device 100 according to the present embodiment. In the process when activating the communication device, it is determined whether the communication device 100 has been reactivated a predetermined number of times or more based on the log information stored in the storage unit 104 in S101. The predetermined number of times is a predetermined number of repeated times, and is the number of times which can be determined that the communication device has repeatedly been reactivated due to the failure that has occurred in the communication device 100. There is also a case where it is assumed that the communication device is repeatedly activated when the reactivation is executed due to the failure of the communication device 100. In this case, the predetermined number of times may be one.

When the determination is YES in S101, the communication device 100 is connected to the network N1 by the first communication unit 102 in S102. The notification information is transmitted to the management server 200 by the circuit-switched communication method via the network N1. The transmitted notification information includes the error information stored in the storage unit 104. In S103, the communication device 100 is connected to the network N2 by the second communication unit 103. The communication via the network N2 is started. However, if the communication device 100 is repeatedly reactivated, the connection to the network N2 is interrupted even when the process of S103 is executed. On the other hand, when the communication device 100 is activated normally after the reactivation is repeated, the communication by the packet communication method via the network N2 is continued after the process of S103 is executed. Then, the process of activation ends.

If the determination is NO in S101, the process of S103 is executed. That is, when the number of reactivations of the communication device 100 is less than the predetermined number of times, the process of S103 is executed. Thereby, when the communication device 100 is normal and normally started without reactivation, the communication via the network N2 is started. On the other hand, even in a case where the reactivation is repeated due to the failure that has occurred in the communication device 100 but the number of reactivations is still less than the predetermined number of times, the process of S103 is executed. However in this case, the communication device 100 is reactivated even when the process of S103 is executed, and the connection to the network N2 is cut off. When the number of reactivations of the communication device 100 reaches the predetermined number, the determination is YES in S101, and the notification information is transmitted via the network N1.

As described above, the control unit 101 of the present embodiment transmits, to the management server 200, the notification information by the circuit-switched communication method via the network N1 when the communication device 100 is reactivated. Consequently, as described above, it is possible to completely transmit the notification information quicker than in a case where the notification information is transmitted by the packet communication method via the network N2. Therefore, it is possible to prevent the communication device 100 from being reactivated again before the notification information is completely transmitted to the management server 200 in a state where the communication device 100 is repeatedly reactivated. Accordingly, it is possible to provide a notification that a failure has occurred in the communication device 100 provided in the vehicle.

Modified Example

Moreover, when receiving the notification information from the communication device 100, the management server 200 may notify a terminal associated with a user of the vehicle on which the communication device 100 is mounted that a failure has occurred in the communication device 100. Examples of the terminal associated with the user include a smartphone, a mobile information terminal, or a computer, owned by the user. When the management server 200 provides a notification that a failure has occurred in the communication device 100, the terminal associated with the user displays that a failure has occurred in the communication device 100 on a display unit, such as a display provided in the terminal. Accordingly, the user of the vehicle on which the communication device 100 is mounted can realize that a failure has occurred in the communication device 100.

Further, the failure that occurs in the communication device 100 according to the present embodiment is a hardware failure, such as an abnormal voltage or abnormal heat generation. However, a failure that may occur in the communication device 100 is not limited to hardware failures. A failure that may occur in the communication device 100 may be a software failure. The software failure is detected by, for example, a watchdog timer. For example, in a case where the control unit 101 does not reset the watchdog timer for a certain period of time, the watchdog timer determines that a failure has occurred in the software system. The watchdog timer transmits, to the control unit 101, a signal including instruction to reset the communication device 100. The control unit 101, which has received the signal including instruction to reset the communication device 100, reactivates the communication device 100. At this time, the control unit 101 stores the error information and the log information in the storage unit 104.

Furthermore, the control unit 101 of the present embodiment recognizes that the communication device 100 has been reactivated through the log information stored in the storage unit 104 by the failure detection unit 105. Well-known methods can be adopted as a method for the control unit 101 to recognize that the communication device 100 has been reactivated.

### Second Embodiment

In the second embodiment, when the communication device 100 is reactivated the predetermined number of times, the communication device 100 transmits the notification information by the packet communication method via the network N2. At this time, the communication device 100 may be unable to completely transmit the notification information because the communication device 100 may be reactivated before the notification information is completely transmitted via the network N2. In this case, the communication device 100 transmits, to the management server 200, the notification information by circuit-switched communication method via the network N1.

When the notification information is completely transmitted via the network N2, the control unit 101 causes the storage unit 104 to store completion information indicating that the notification information is completely transmitted via the network N2. At this time, as described in the first embodiment, the communication device 100 may be reactivated again before the control unit 101 completely transmits the notification information via the network N2. In this case, the storage unit 104 does not store the completion information. Therefore, the control unit 101 can determine whether the notification information is completely transmitted by the packet communication method depending on whether the completion information is stored in the storage unit 104.

Process at Activation

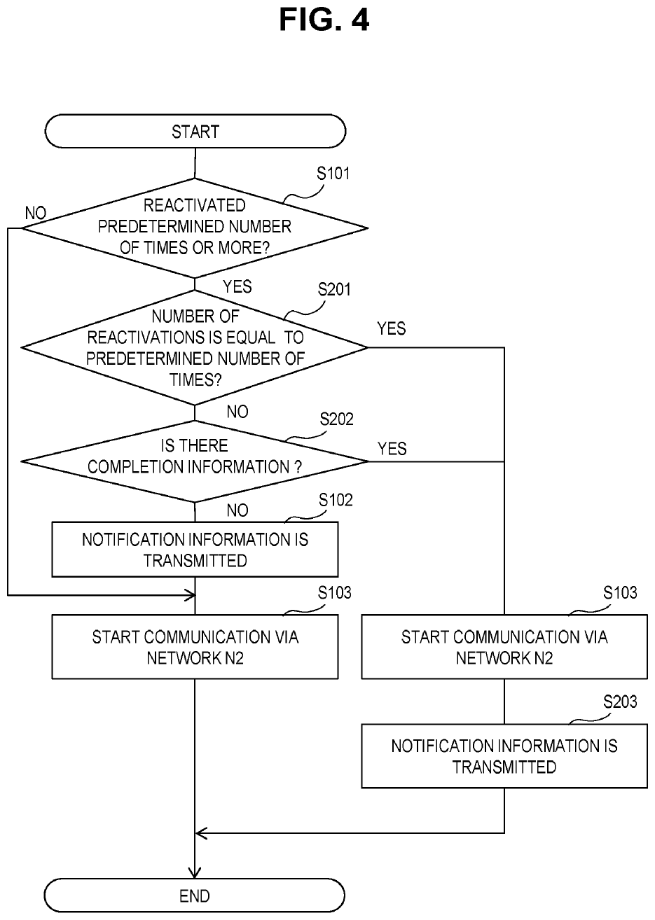

Next, a process executed by the control unit 101 when activating the communication device 100 in the information management system 1 according to the present embodiment will be described with reference to FIG. 4. FIG. 4 is a flowchart illustrating the process when activating the communication device 100 according to the present embodiment. The processes from S101 to S103 in this flowchart are the same as the processes from S101 to S103 in the flowchart illustrated in FIG. 3, respectively. Therefore, the descriptions thereof will be omitted.

In the process when activating the communication device, in a case where the determination is YES in S101, it is determined whether the current number of times the communication device 100 is reactivated is equal to a predetermined number of times based on the log information in S201. If the determination is YES in S201, the process of S103 is executed. In S203, the notification information is transmitted to the management server 200 by the packet communication method via the network N2 after the notification information is divided, in advance, into packets. Consequently, when the communication device 100 is reactivated the predetermined number of times, the control unit 101 transmits the notification information via the network N2. When the notification information is completely transmitted to the management server 200 via the network N2, the completion information is stored in the storage unit 104. On the other hand, even if the processes of S103 and S203 are executed, when the communication device 100 is reactivated before the notification information is completely transmitted, the connection to the network N2 is cut off. In this case, the notification information is not completely transmitted to the management server 200, thus the completion information is not stored in the storage unit 104.

Further, in a case where the determination is NO in S201 (that is, in a case where the communication device 100 is reactivated more than the predetermined number of times), it is determined whether the completion information is stored in the storage unit 104 in S202. That is, when the communication device 100 is reactivated the predetermined number of times, it is determined whether the notification information is completely transmitted via the network N2. In a case where the determination is YES in S202 (that is, it is determined that the completion information is stored), the processes of S103 and S203 are executed. In a case where the determination is NO in S202 (that is, it is determined that the completion information is not stored), the process of S102 is executed. Accordingly, the notification information is transmitted to the management server 200 by the circuit-switched communication method via the network N1.

As described above, the control unit 101 of the present embodiment transmits, to the management server 200 via the network N2, the notification information when the communication device 100 is reactivated the predetermined number of times. In a case where the notification information is successfully transmitted via the network N2, the control unit 101 does not transmit the notification information via the network N1. Furthermore, in a case where transmission of the notification information via the network N2 fails, the control unit 101 transmits the notification information via the network N1 at the next reactivation. It is also possible to provide a notification that the failure has occurred in the communication device 100 provided in the vehicle.

Modified Example

When the information is transmitted by the circuit-switched communication method, unlike when the information is transmitted by the packet communication method, the data capacity that can be transmitted may be limited. The control unit 101 reduces the data capacity of the notification information in a case where it fails to transmit the notification information via the network N2. The control unit 101 transmits, to the management server 200 via the network N1, the notification information having the reduced data capacity. For example, even if the notification information transmitted to the management server 200 does not include the error information for identifying the cause of the failure that has occurred in the communication device 100, at least the information indicating that the failure has occurred in the communication device 100 is notified. In a case where the notification information is transmitted via the network N1 because transmission of the notification information via the network N2 fails, the error information may be deleted from the notification information. Accordingly, even in a case where the data capacity of the notification information exceeds the upper limit that can be transmitted by the network N1 when the notification information includes error information, it is possible to notify the management server 200 that a failure has occurred in the communication device 100.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the process described as being performed by a single device may be executed in a shared manner by a plurality of devices. Alternatively, the process described as being performed by various devices may be executed by a single device. In the computer system, the hardware configuration (server configuration) for implementing each function can be flexibly changed.

The present disclosure can also be implemented by supplying a computer program for executing the functions described in the embodiments in a computer, and reading and executing the program by one or more processors included in the computer. Such a computer program may be provided to the computer by a non-transitory computer-readable storage medium connectable to a computer system bus, or may be provided to the computer via the network. Examples of the non-transitory computer-readable storage medium include a random disk (such as a magnetic disk (a floppy® disk an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. A communication device provided in a vehicle, the communication device comprising:
a control unit configured to:
start communication by a packet communication method in a case where the communication device is activated normally when activating the communication device; and
transmit, to a predetermined server device, by a circuit-switched communication method, notification information for providing a notification that a failure has occurred in the communication device in a case where the communication device is reactivated when activating the communication device.

2. The communication device according to claim 1, wherein the control unit is configured to transmit, to the predetermined server device, the notification information by the circuit-switched communication method in a case where the communication device is repeatedly reactivated a predetermined number of times or more when activating the communication device.

3. The communication device according to claim 1, wherein the control unit is configured to transmit, to the predetermined server device, the notification information by the packet communication method in a case where the communication device is reactivated when activating the communication device, and not to transmit the notification information by the circuit-switched communication method in a case where the notification information is successfully transmitted by the packet communication method.

4. The communication device according to claim 3, wherein the control unit is configured to, in a case where it is not possible to complete the transmission of the notification information to the predetermined server device by the packet communication method, reduce data capacity of the notification information and transmit, to the predetermined server device, the notification information by the circuit-switched communication method.

5. The communication device according to claim 1, wherein the notification information includes error information for identifying a cause of the failure that has occurred in the communication device.

6. An information processing method executed by a communication device provided in a vehicle, the information processing method comprising:
starting communication by a packet communication method in a case where the communication device is activated normally when activating the communication device; and
transmitting, to a predetermined server device, by a circuit-switched communication method, notification information for providing a notification that a failure has occurred in the communication device in a case where the communication device is reactivated when activating the communication device.

7. The information processing method according to claim 6, further comprising transmitting, to the predetermined server device, the notification information by the circuit-switched communication in a case where the communication device is repeatedly reactivated a predetermined number of times or more when activating the communication device.

8. The information processing method according to claim 6, further comprising:
transmitting, to the predetermined server device, the notification information by the packet communication method in a case where the communication device is reactivated when activating the communication device; and
not transmitting the notification information by the circuit-switched communication method in a case where the notification information is successfully transmitted by the packet communication method.

9. The information processing method according to claim 8, further comprising reducing data capacity of the notification information and transmitting, to the predetermined server device, the notification information by the circuit-switched communication method in a case where it is not possible to complete the transmission of the notification information to the predetermined server device by the packet communication method.

10. The information processing method according to claim 6, wherein the notification information includes error information for identifying a cause of the failure that has occurred in the communication device.

11. A system comprising:
a communication device provided in a vehicle; and
a server device,
wherein the communication device is configured to:
start communication by a packet communication method in a case where the communication device is activated normally when activating the communication device; and
transmit, to a predetermined server device, by a circuit-switched communication method, notification information for providing a notification that a failure has occurred in the communication device in a case where the communication device is reactivated when activating the communication device.

12. The system according to claim 11, wherein the communication device is configured to transmit, to the server device, the notification information by the circuit-switched communication method in a case where the communication device is repeatedly reactivated a predetermined number of times more when activating the communication device.

13. The system according to claim 11, wherein the communication device is configured to transmit, to the server device, the notification information by the packet communication method in a case where the communication device is reactivated when activating the communication device, and not to transmit the notification information by the circuit-switched communication method in a case where the notification information is successfully transmitted by the packet communication method.

14. The system according to claim 13, wherein the communication device is configured to, in a case where it is not possible to complete the transmission of the notification information to the server device by the packet communication method, reduce data capacity of the notification information and transmit, to the server device, the notification information by the circuit-switched communication method.

15. The system according to claim 11, wherein the notification information includes error information for identifying a cause of the failure that has occurred in the communication device.

16. The system according to claim 11, wherein the server device is configured to, when receiving the notification information from the communication device, notify a terminal associated with a user of the vehicle that the failure has occurred in the communication device.
